(19) United States
(12) Patent Application Publication
(10) Pub. No.: US 2010/0037127 A1
(43) Pub. Date: Feb. 11, 2010

(54) APPARATUSES, SYSTEMS, AND METHODS TO AUTOMATE A PROCEDURAL TASK

(75) Inventors: Anthony Slavko Tomasic, Pittsburgh, PA (US); John Doyle Zimmerman, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(73) Assignee: Carnegie Mellon University, Pittsburgh, PA (US)

(21) Appl. No.: 12/373,233

(22) PCT Filed: Jul. 11, 2007
(86) PCT No.: PCT/US07/15742

§ 371 Date: Jul. 23, 2009

Related U.S. Application Data
(60) Provisional application No. 60/819,999, filed on Jul. 11, 2006.

(51) Int. Cl. G06F 17/00; G06F 3/048; G06F 3/01; G06F 9/46

(52) U.S. Cl. 715/224; 715/764; 715/751; 718/101

(57) ABSTRACT

Methods, apparatuses, and systems to automate a procedural task. In one embodiment, computer-readable memory including computer readable instructions which, when executed by a processor, cause the processor to perform steps comprising: identifying a set of data, wherein the data includes a plurality of items; prompting the user to process at least one item of the data in a predetermined manner, wherein the user interacts with a predetermined form system to process the data; monitoring input of the user, wherein the input of the user causes the at least one item of the data to be processed in the predetermined manner; producing computer-generated, computer-readable instructions in response to monitoring the input of the user, wherein the computer-generated, computer-readable instructions cause the processor to process data in the predetermined manner; and executing the computer-generated, computer-readable instructions, wherein the computer-generated, computer-readable instructions operate on at least one item of the data.

### CROSS-REFERENCE TO RELATED APPLICATIONS

This application claims priority from U.S. Provisional patent application Ser. No. 60/819,999, filed Jul. 11, 2006, and which is incorporated herein by reference.

### STATEMENT REGARDING FEDERALLY-SPONSORED RESEARCH AND DEVELOPMENT

This invention was made, at least in part, with United States government support under DARPA No. NBCHD030010. The United States government may have certain rights in this invention.

### FIELD OF THE INVENTION

The present invention is directed generally to methods, apparatuses, and systems to automate a procedural task and, more specifically, to such methods, apparatuses, and systems which utilize workflow by example and other implementations.

### BACKGROUND OF THE INVENTION

Batch updates to databases are generally implemented using a combination of workflow tools and “extract, transform, and load” (ETL) tools. The addition of a new batch update procedure using these tools requires careful consideration of data cleaning, duplicate record elimination, record linkage, and other issues. Thus, in general, systems are engineered such that “point” updates are handled through manual update via forms and very large updates are handled through workflows. Medium sized updates (between two and fifty updates at a once, possibly adding up to thousands of updates over time) are often left unsupported. These medium sized updates are done manually through the form system. This manual process is slow, expensive, and error prone.

Other intelligent workflow composition systems [see, for example, Marc Spraragen Jihie Kim and Yolanda Gil, An intelligent assistant for interactive workflow composition. In Proceeings of the International Conference oh Intelligent User Interfaces (IUI-2004). ACM Press, 2004.], combine ontological knowledge about the inputs and outputs of available workflow services with AI planning techniques to construct workflows. However, these systems require knowledge-rich descriptions of the available systems, including constraints.

Accordingly, there is a need for improved apparatuses and systems to automate procedural tasks. In particular, there is a need for apparatuses and systems for creating workflows from captured information at the backend, requiring a change to low-level driver interactions, rather than high-level workflow descriptions of each component. In fact, access to the backend includes databases with an SQL interface, software as a service systems with SQL-like languages, or any application interface. These and other advantages of the present invention will be described in more detail hereinbelow.

### BRIEF SUMMARY OF THE INVENTION

The present invention addresses problems with the prior art and allows users to construct their own workflows and for a computer system to learn to automate the process of completing these workflows by monitoring user's demonstrations of workflows. Over time the system begins to complete parts of the workflow and then monitors the user' actions—such as accepting, ignoring, or repairing the system contribution—and then uses these new examples to improve performance.

One embodiment of the present invention is the Workflow By Example (WbE) system. Although the present invention will be described in terms of WbE, other variations, modifications, and embodiments of the present invention are possible.

WbE is a system that learns to execute complex transactions. The system learns by interaction with the user during the execution of example complex transactions. The system learns new transactions by generalizing the complex transaction examples.

The present invention includes apparatuses and systems, called Workflow by Example (WbE), that allows a user (such as a developer) to create workflow scripts by providing a set of input items, demonstrating the workflow necessary to complete a task for at least one item using familiar forms and an example interaction. The system examines the user's interaction and generates a parameterized script as a result. The script is executed over the remaining input items, and any exceptions are presented to the user, allowing the user to create new scripts for processing these exceptions. The resulting set of scripts, called a workflow program, is then saved for future use. This workflow program can be shared with other for collaborative work. Thus, WbE provides a low effort and low cost method for developers to create workflows. Thus, developer teams can cost-effectively support medium sized updates.

Workflow and Other Database Systems

Workflow by Example is unique among database manipulation and workflow systems. While it shares some similarities with Query-by-example (“QbE”) [see, for example, Moshe M. Zloof. Query-by-example: A data base language. IBM Systems Journal, 16(4):324-343, 1977.], such as constructing generalized queries from user examples, it differs greatly in that user input takes the form of whole sequences of SQL, captured out of the sight of the user. These sequences are generalized in ways that go beyond data retrieval, to allow for the creation of workflow scripts.

Unlike standard workflow development processes [see, for example, C. Mohan. Workflow management in the internet age (abstract). In NGITS, page 237, 1999.], tools, or languages [see, for example, Frank Leymann. Web services flow language (wsfl 1.0). Technical report, IBM Corporation, May 2001 2001.], WbE puts the creation of workflow in the hands of the end user, allowing them to construct and automate more complex behaviors from those built into a given system.

Programming By Example Systems

Unlike most programming by example (“PbE”) systems [see, for example, Henry Lieberman, editor. Your Wish is My Command: Programming by Example. Academic Press, 2001.], workflow by example (“WbE”) uses a form system's interactions with its support database (or external application call) as an access point for capturing user behavior. Like some PbE systems designed for tasks like web browsing [see, for example, Atsushi Sugiura. Web browsing by example. In Henry Lieberman, editor, Your Wish Is My Command: Programming by Example, pages 62-85. Academic Press, 2001.] and information extraction from the web [see, for example, Mathias Bauer, Dietmar Dengler, and Gabrielle Paul. Trainable information agents for the web. In Henry Lieberman, editor, Your Wish Is My Command: Programming by Example, pages 88-89. Academic Press, 2001.], WbE's interface is a form system, and the user interacts with it by copying and pasting values between the application or database's results and WbE's form interface. However, while these other systems focus on the HTML as the access point for performing inference on the user's actions, WbE looks to the actions performed on the database or external application itself, operating on sequences of SQL or application calls rather than portions of HTML. The form system may be implemented, for example, as a web browser. Other variations of the form system are also possible.

WbE is similar to programming by example systems like SMARTedit [see, for example, Tessa Lau, Steven A. Wolfman, Pedro Domingos, and Daniel S. Weld. Learning repetitive text-editing procedures with SMARTedit. In Henry Lieberman, editor, Your Wish Is My Command: Programming by Example, pages 210-225. Academic Press, 2001.], which capture a sequence of actions in a fashion similar to a macro recorder, then reason on these sequences in the background. WbE again differs from such systems based on the access point for interaction capture, but also based on the type of learning used. While SMARTedit uses a formalized version space algorithm with multiple examples for searching and pruning the generalization space, WbE currently relies upon a more biased set of heuristics to drive generalization based on only one example. Lau and Weld [see, for example, Tessa A. Lau and Daniel S. Weld. Programming by demonstration: An inductive learning formulation. In Proceedings of IUI '99, pages 145-152. ACM Press, 1999.] discuss an extension to the version space algorithm that may apply to WbE.

In terms of the examples presented herein, which use web-based forms systems to perform queries and updates, WbE competes with web-based programming systems such as Chickenfoot [see, for example, Michael Bolin and et al. Automation and customization of rendered web pages. In UIST' 05, pages 163-172. ACM Press, 2005.]. Both WbE and Chickenfoot can be used to construct workflows over web-based forms, and both systems use user interfaces which are embedded in the web browser. The present invention is different from the prior art in several important ways, such as the access point. Chickenfoot uses textual relationships, combined with the browser Document Object Model (DOM) to perform information extraction and query submission via web pages. This method is very complex, requiring strong text parsing, and suffers from brittleness on systems with interfaces that are dynamic or prone to redesign. On the other hand, WbE's access point makes information extraction and workflow execution much easier, because of the relatively simple structure of external application calls, and of the SQL query language, and programmatic access available through JDBC.

Another aspect of WbE is its tight integration of exception handling and opportunities for additional learning. A user provides a set of input items as the first step of interacting with WbE, and the user provides an example of processing an item. WbE learns a rule from this first item and then applies the rule to the rest of the items. The result of the application is then analyzed for exception. Each class of exception is provided to the user as a new opportunity to provide examples of processing to WbE.

WbE provides a relatively simple user interaction (upload a file, demonstrate an example, initiate learning and execution). Additionally, should WbE fail to create a script from the provided example, or encounter inputs that cause the script to fail, the user is given the opportunity to try recording a new script, using the remaining unhandled examples. WbE's learning algorithm leverages the input file from the user for hints as to which values in the captured interaction are meant to be parameters for future execution. The scripts created by WbE's learning algorithm accurately reproduce the action in the recorded examples, so each example provided by the user is guaranteed to work.

WbE also allows the user the ability to test the performance of a script, by initially running it in a ‘preview’ mode, presenting the successes and failures to the user for review before committing changes to the database. Preview mode allows users to experiment and debug scripts without changing the production values in a database.

The present invention includes many variations, modifications, and embodiments. For example, at the application level, the present invention is a system to learn sequences of IT transactions, a data integration system based on learned rules, a repository creation system based on learned rules, a workflow system based on learned rules, a side-information lookup system based on learned rules, and an integration constraint checking system based on learned rules.

The present invention is a system to use the DBMS client interface or external application interface as the access point for learning.

Regarding learning, the present invention is a system to combine information analysis of inputs, intermediate steps, and output with rules during learning; the present invention is a system to use reference resolution techniques with rules during learning; and the present invention is a system to use classification with rules during learning.

Regarding cooperative aspects, the present invention is a system to accomplish cooperative transactions in combination with learning rules; a system to share learned rules with a community of users; a system to use field value matching as its input and output; and a system to use UI widget pairing as its input and output.

Many variations are possible with the present invention. For example, although the present invention is described in terms of using a web browser as an interface, the present invention is not limited to the use of a web browser, and the present invention may be used without a web browser. These and other teachings, variations, and advantages of the present invention will become apparent from the following detailed description of the invention.

### BRIEF DESCRIPTION OF THE SEVERAL VIEWS OF THE DRAWING

Embodiments of the present invention will now be described, by way of example only, with reference to the accompanying drawings for the purpose of illustrating the embodiments, and not for purposes of limiting the invention, wherein:

FIG. 1a illustrates one embodiment of a system according to the present invention.

FIG. 1b is a flowchart illustrating one embodiment of computer-readable instructions according to the present invention.

FIG. 2 illustrates one embodiment of the WbE System Architecture. Solid lines indicate data flow. Dashed lines indicate control flow.

FIG. 3 shows an example system input containing a list of last names, first names, and new office numbers.

FIG. 4 shows one embodiment of the WbE user interface. In that embodiment, the user interface sits in a frame below a standard web page.

FIG. 5 shows one embodiment of the WbE UI Capture Interface

FIG. 6 demonstrates one embodiment of a task according to the present invention. The user searches for the employee.

FIG. 7 demonstrates one embodiment of a task according to the present invention. The user selects the employee's record.

FIG. 8 demonstrates one embodiment of a task according to the present invention. The user updates the employee's information.

FIG. 9 shows the WbE Results Page for the example task shown in FIGS. 6-8.

FIG. 10 details examples on which the script succeeded, including outputs table.

FIG. 11 details examples on which the script failed.

FIG. 12 illustrates Iterative vs. Hashing algorithm in best-case and worst-case learning conditions.

FIG. 13 illustrates execution times for WbE script vs. Handwritten Java Program for one example.

FIG. 14 shows a log file of the captured task.

FIG. 15 shows a rule and associated variables from inference procedure.

FIG. 16 illustrates another embodiment of a WbE system according to the present invention.

### DETAILED DESCRIPTION AND BEST MODE OF IMPLEMENTATION

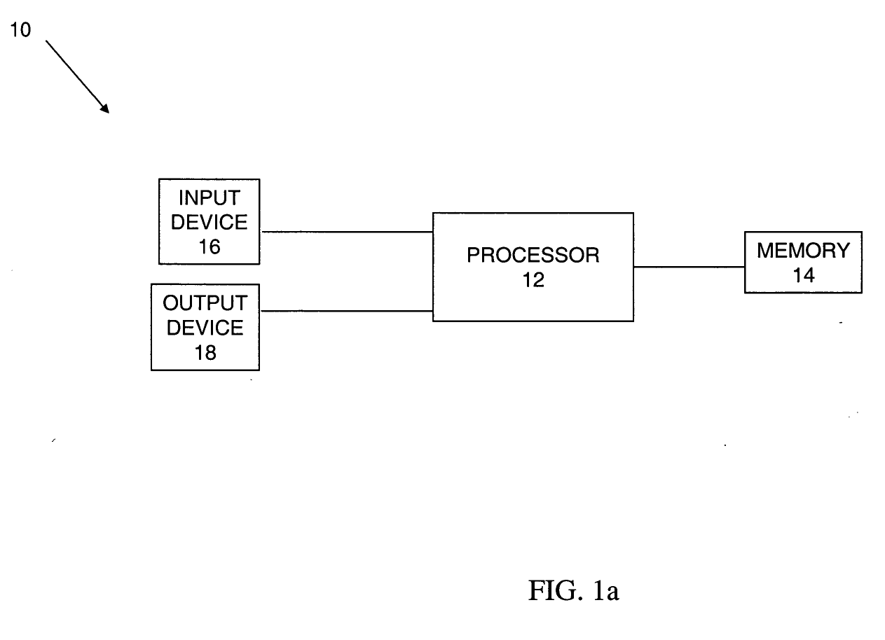

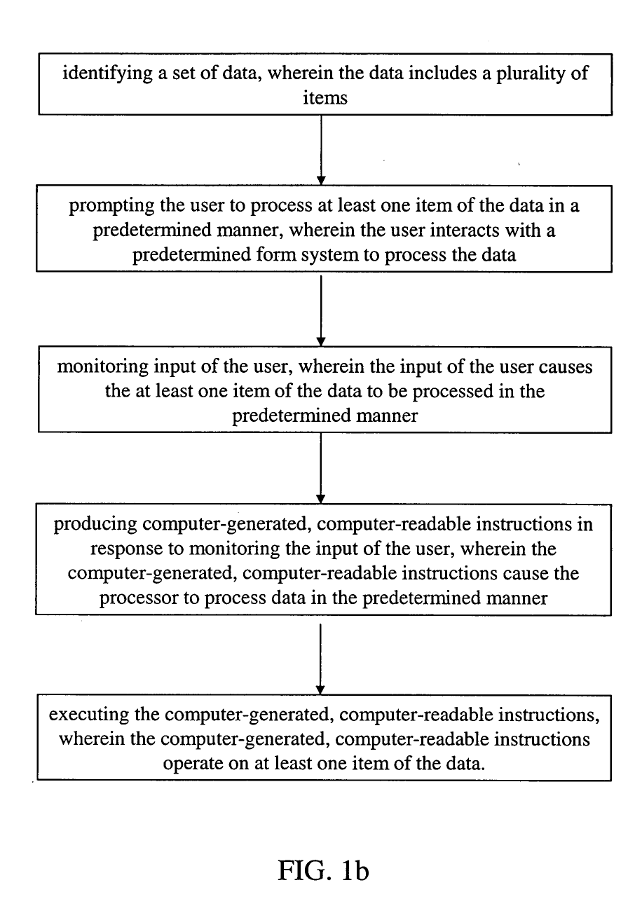

FIG. 1a illustrates one embodiment of a system 10 according to the present invention. In that embodiment, the system 10 includes a processor 12, memory 14, an input device 16, and an output device 18. The processor 12 is connected to the memory 14, the input device 16, and the output device 18. The memory 14 includes computer readable instructions, such as computer hardware, software, firmware, or other forms of computer-readable instructions which, when executed by the processor 12, cause the processor 12 to perform certain functions, as described herein.

The processor 12 receives input from the input device 16, and provides signals to control the output device 18. The processor 12 also performs certain functions, as described herein.

The memory 14 can be any form of computer-readable memory, and may store information in magnetic form, electronic form, optical form, or other forms. The memory includes computer readable instructions which, when executed by the processor 12, cause the processor 12 to perform certain functions, as described herein. The memory 14 may be separate from the processor 12, or the memory 14 may be integrated with the processor 12. The memory 14 may also include more than one memory device, which may be integrated with the processor 12, separate from the processor 12, or both.

The input device 16 may be a keyboard, a touchscreen, a computer mouse, or other forms of inputting information from a user.

The output device 18 may be a video display or other forms of outputting information to a user.

Many variations are possible with the system 10 according to the present invention. For example, more than one processor 12, memory 14, input device 16, and output device 18 may be present in the system 10. In addition, devices not shown in FIG. 1a may also be included in the system 10, and devices shown in FIG. 1a may be combined or integrated together into a single device.

FIG. 1b is a flowchart illustrating one embodiment of computer-readable instructions according to the present invention. The computer readable instructions are stored in the memory 14. When executed by a processor 12, the computer readable instructions cause the processor 12 to perform the following functions.

The computer readable instructions cause the present invention to identify a set of data, wherein the data includes a plurality of items. The data may be identified and provided directly or indirectly by a user (not shown). Alternatively, the data may be provided to the system 10 by other means.

The user is prompted to process at least one item of the data in a predetermined manner, wherein the user interacts with a predetermined form system to process the data. This prompting may be, for example, by providing instructions on the output device 18. The form system is generated by the system 10 and provides a predetermined format to be used by system 10, as described herein, to process interactions with the user 22 and, thereby, to created computer-generated code according to the present invention. The form system is a computer-user interface and it may be implemented in many different ways. In general, the form system will typically includes at least one element such as a text box, pull down, radio button, check box, single selection list, multi-selection list, table, spreadsheet, or combinations thereof. Form systems according to the present invention may also include other elements and other combinations of elements. Because the form system is predetermined and its format is known by the system 10, the system 10 is better able to process the interactions between the user 22 and the system 10, thereby resulting in superior results.

The input of the user is monitored. In particular, the input of the user that causes the at least one item of the data to be processed in the predetermined manner is monitored. The input device 16 and the output device 18 provide for interaction between the user and the system 10. The manner and location in the system 10 at which the present invention monitors the input from the user will be described in more detail hereinbelow.

After monitoring the user, computer-generated, computer-readable instructions are generated and executed. These computer-generated, computer-readable instructions are in response to monitoring the input of the user. The computer-generated, computer-readable instructions, when executed, cause the processor 12 to process data in the same predetermined manner as was done by the user. In particular, the computer-generated, computer-readable instructions operate on at least one item of the data.

Variations of the present invention will be described herein. For example, prompting the user to process at least one item of the data may include executing a predetermined form system, presenting the user with a predetermined form via the predetermined form system, and prompting the user to process at least one item of the data via the predetermined form system.

In another variation, instead of identifying a set of data, the user provides access to at least one data source consisting of a plurality of items.

In another variation, prompting the user to interact with a predetermine form system to process at least one data item from at least two data sources.

In another variation, the predetermined form system includes the ability to search for data, wherein search includes Boolean search, vector space search, any statistical relational learning algorithm or other methods of identifying data understood in the art.

In another variation, instead of identifying a set of data, the data arrives as a message from an external data source.

In another variation, monitoring input of the user, wherein the input of user causes part of at least one item of data to be processed in the predetermined manner.

Those and other variations of computer-generated, computer-readable instructions are possible with the present invention.

Architecture

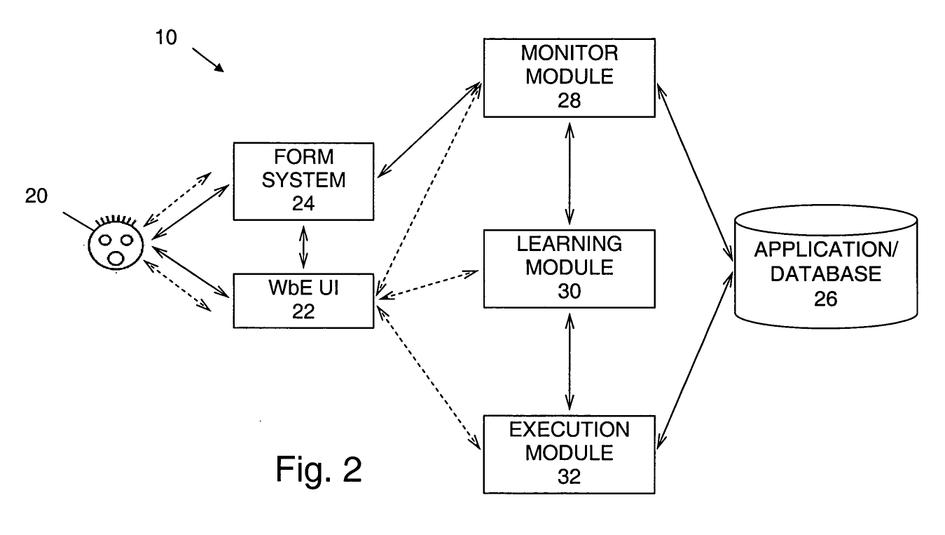

FIG. 2 illustrates one embodiment of the architecture of the workflow by example (“WbE”) system 10. In this figure, solid lines indicate data flow and dashed lines indicate control flow.

One or more users 20 interact directly with the WbE system 10 through the user interface (“UI”) 22 by providing input files, examples, and commands (such as “Execute”). Users 20 interact indirectly with the system 10 by completing tasks with a form system 24. Task completion is accomplished through a sequence of interactions with the form system 24. This sequence creates an information exchange between the form system 24 and the application/database 26. This exchange is logged by the monitor module 28.

Through the user interface 22, the user 20 can control the monitor module 28, provide input to the system 10 for inference and execution, paste in values from the form system 24 to describe the output of a task, and initiate script creation and execution.

When a user 20 initiates script creation, the user interface 22 passes the input file, output pasted by the user 20, and the captured log to the learning module 30. The module 30 compares the log with the provided example interaction to create a generalized script for the captured task. This script is stored in the learning module 30. After successful script creation, the system 10 passes the script, and the remaining input examples, to the execution module 32, which executes the script on the examples without committing changes to the database 26. The user 20 reviews the results of execution, and commits the successful examples if they are satisfied with them. Exceptions to the script can be handled by recursively using the WbE interface 22 to define a new script for dealing with the examples which failed to execute in the first script. Finally, the user 20 can name and store the script permanently for future use.

The form system 24, monitor module 28, learning module 30, execution module 32, and application/database 26 may be stored in one or more memory devices 14. The form system 24, monitor module 28, learning module 30, and execution module 32 may be executed by one or more processors 12. The user interface 22 may be implemented as software executed by the processor 12 and operated with the use of the input 16 and output 18 devices.

### Example

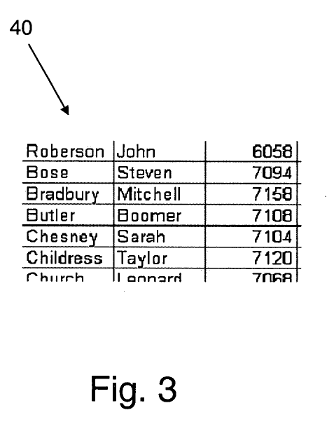

FIG. 3 shows part of an example input file 40 that contains a list of employees and new office numbers. In this example task, a user must update a set of records in a database 26 with new office room numbers.

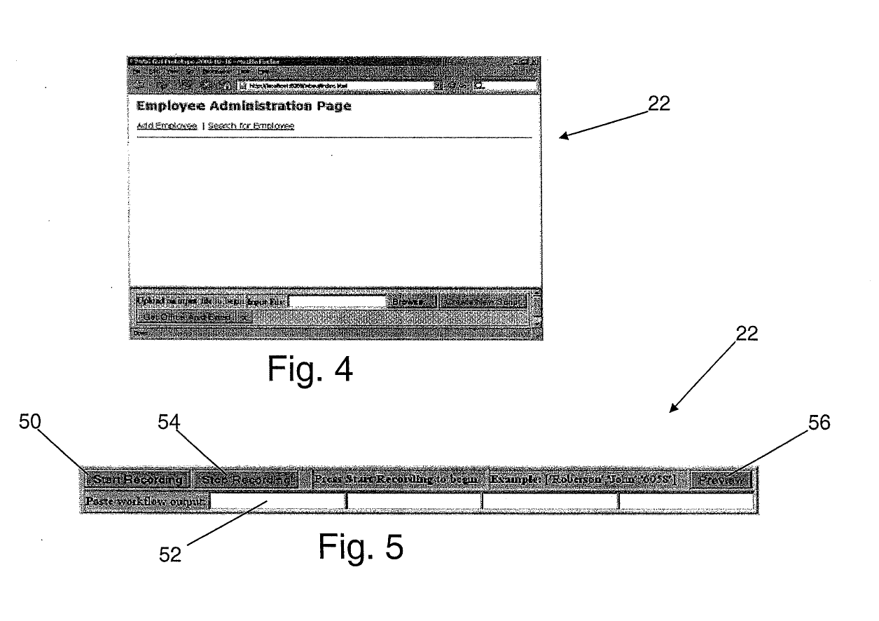

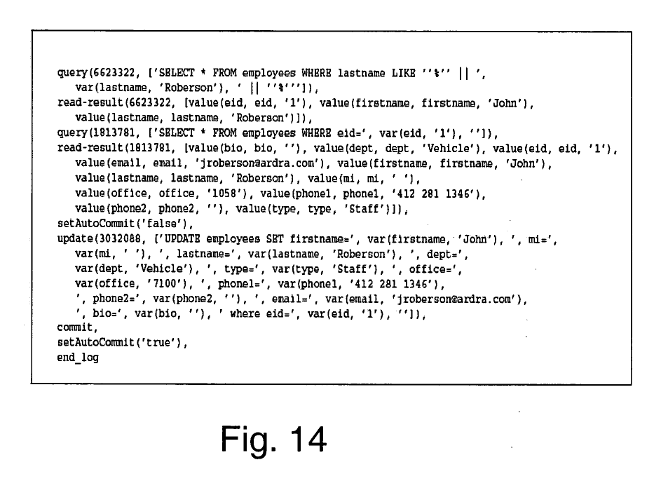

FIG. 4 illustrates one example of the user interface 22. The user starts the interaction sequence with system 10 by presenting the input file to the user interface 22. The input file may be presented to the user interface, for example, by using a conventional “browse” feature to identify the input file to the user interface, by a “drag and drop” operation, or by any other means to identify the input file to the user interface 22. In the illustrated embodiment, the user interface 22 is a frame in a standard web browser, although the user interface 22 may take other forms in other embodiments. The user interface 22 responds to the input file by presenting to the user the first example in the input file: (‘Roberson’, ‘John’, ‘6058’). The user navigates to the appropriate form. The user then begins task capture by pressing the Start Recording button 50 (FIG. 5) in the user interface 22, causing the system 10 to create a blank log file and begin logging the application/database interaction. FIG. 14 illustrates a sample log file of a captured task.

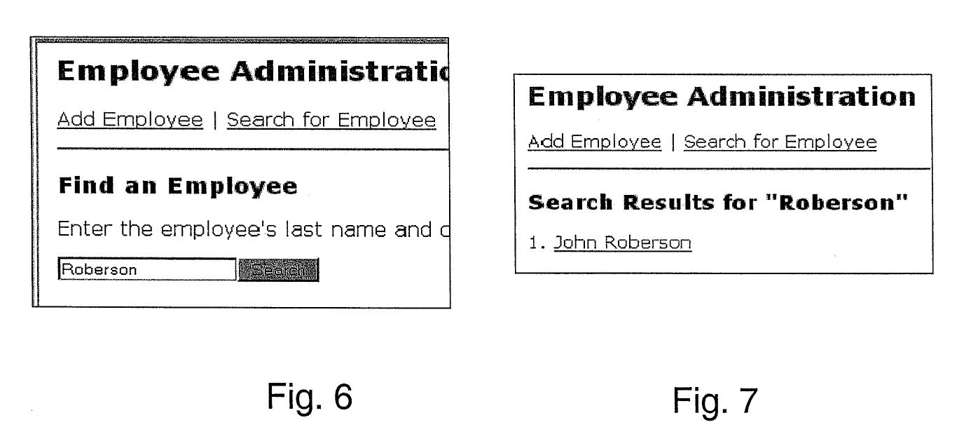

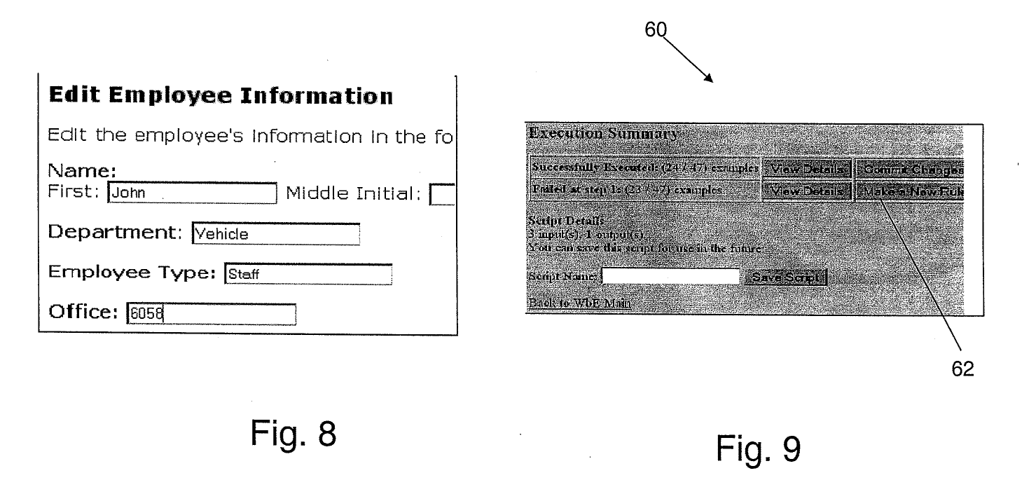

Using the first element in the input list 40 (FIG. 3), the user performs the office location change task, exactly as the user normally would. As illustrated in FIGS. 6 through 8, the user searches for the employee based on last name, and selects the employee's details from the search results. For verification, the user captures each employee's old office location as output for the workflow by copying the old office value (‘1058’) from the employee's record into one of the workflow output fields 52 in the user interface 22 (FIG. 5). The user then updates the office number to the new value (‘6058’) and saves the changes, completing the task.

Once the example employee has been processed, the user presses Stop Recording 54 (FIG. 5) to end capture and close the log. User interface 22 now is ready to generate and preview a script using the prepared input file, output values, and interaction log.

The user initiates script generation and execution by pressing the Preview button 56 (FIG. 5), causing the learning module 30 to generate a script, and execute the script in Preview mode. Preview mode executes the script on each example, preventing it from actually altering the database 26. In other words, the user 20 must review and approve the results of the system 10 before the changes are actually made to the database 26. This may be done, for example, by using one portion of the memory device 14 to store data indicative of the desired processing of the data (e.g., the database 26 containing the processed data), and by using another portion of the memory 14 (or a portion of a different memory device 14) to store temporary data indicative of the results of the computer-generated code or script. If the user approves the data produced by the computer-generated code, it is moved to the database 26 or whatever other portion of the memory 14 is used to store the processed data. However, it is also possible to utilize the present invention without this safety feature. In other words, it is possible to operate the present invention so that changes to the database 26 occur automatically, without requiring review and approval by the user 20.

During execution, the system 10 collects information about the success and failure of the script with respect to each example. After execution, the user interface 22 presents a user 20 with a results page 60 (FIG. 9) that summarizes the status of all input tuples with respect to the script's success or failure.

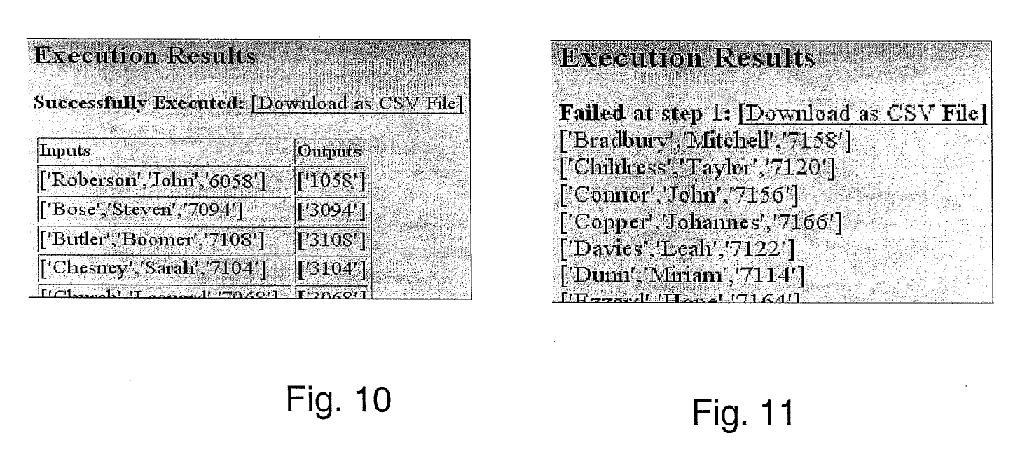

For this example, the task yielded 24 successes (including the original example), and 23 failures (all of which failed at the first step of the script). The user examines the details of execution for both the successful examples (see FIG. 10) and those that failed at the first step (see FIG. 11). The failed inputs were the result of including employees in the input file 40 (FIG. 3) that were not yet in the database 26 (causing the script to fail when it attempted to look up a non-existent employee). However, the reason for the failure is not immediately visible to the user, as the interface 22 indicates only that the examples failed during the first step of script execution. To discover the reason for failure, the user walks through the workflow manually, finding that searching for the people in the list of failures turns up nothing. To handle the examples for missing people, the user presses the Make a New Rule button 62 on the preview page (FIG. 9). This action recursively calls WbE to handle the failed input. Thus, a new WbE window appears with the form system's home page at the top and the user interface 22 recording controls (FIG. 5) at the bottom. The first row of the set of failed examples appears as input for driving a new task demonstration. Beginning with pressing the Start Recording button 50 (FIG. 5), the user proceeds through the steps described earlier, replacing the original demonstration of looking up and editing an employee with a demonstration of adding a new employee to the database using the form system 24. Finally, the user saves the workflow program.

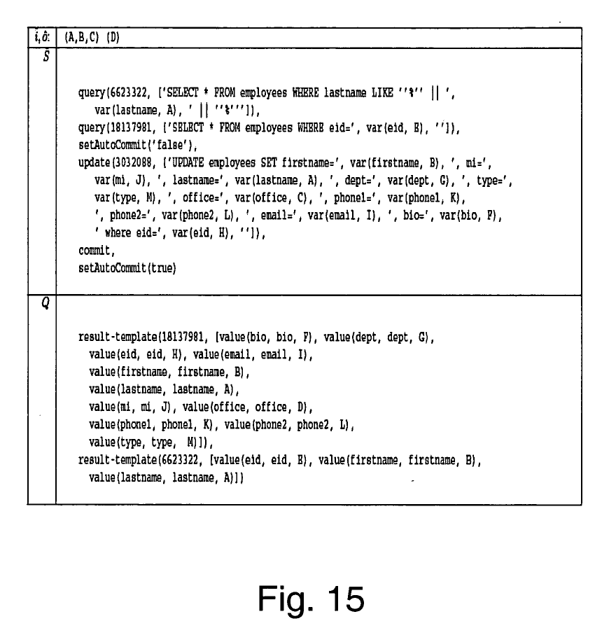

The program now consists of two scripts: the first script to handle office modification and the second script to handle new users. The second script is only run for examples which the first script fails to locate in the database 26, effectively creating a conditional execution depending on whether a given example exists in the database 26. FIG. 15 shows a rule and associated variables from inference procedure.

Research Issues and Scope

The following sections describe the research issues that guided the design and implementation of the WbE embodiment of the present invention.

Access Point to Application Behavior

The WbE embodiment of the present invention uses the connector between the user's form system 24 and the supporting application/database 26 as its access point. This access point allows WbE to log every interaction between the form system 24 and application/database 26, filtered through the logic of the form system 24. The log contains the raw SQL requests as they passed from the form system 24 to the database 26, and the results sets that are pass back. The capture is described in more detail hereinbelow in the Section entitled “Method” and in those sections following the “Method” Section. Compared to other access points, such as the HTML requests and responses, SQL logs contain more precise, typed and formatted information.

Expressive Power of Learning Module

One of the goals of WbE is to learn a generalized program from the log and the set of input strings that drive the interaction captured in the log. Since the logs are potentially large, the complexity of the learning algorithm is a significant bottleneck. To this end, we use an inductive algorithm that generalizes the parameter values of queries and update that appear in the log. The algorithm allows for the reproduction of single-path interactions for each input, with no internal loops or conditionals. The algorithm simplified the learning requirements for WbE, while still providing enough flexibility to create a wide range of workflow scripts. Still, complexity of the learning algorithm proved to be a problem. The Section hereinbelow entitled “Method”, and in sections following the “Method” Section, describes a modification of the algorithm that improved performance significantly.

Benefits to the User

WbE would not be useful if it performed worse than doing the tasks by hand. WbE is designed to benefit users even for tasks requiring only a few repetitions. The design includes a lightweight upload interface, a lightweight recording interface, and previews of updates to prevent errors. An evaluation of user performance shows that users have no difficulty learning to use WbE. In addition, the evaluation empirically measures the break even point for using WbE verses manual execution of a simple task.

Scope

The scope of WbE is defined by the algorithm used in the learning module 30. Each invocation of the algorithm generates a script for one interaction path through an form system 24. The path contains the sequence of SQL queries and updates invoked by the form system 24. Thus, WbE leverages the power of SQL. Users 20 develop workflow programs that are sets of conditionally executed scripts. The program is driven by a single outerloop that processes the input file. The algorithm does not, however, learn “inner” loops.

Model

WbE operates on lists of input tuples, each of which provides the information necessary to perform an unknown (to WbE) action. The user 20 demonstrates this action on the first input tuple in the list, producing an execution log. The execution log represents an example execution of a program in a fixed language, containing both the statements that were executed (queries and updates) and any results returned. (The user 20 may also copy any of the results of their actions into an example output tuple.)

The task for WbE is to use the input/output tuples and the execution log to create a program which will accurately reproduce the execution history the recorded example and which will work ‘correctly’ on the other input tuples. This task is accomplished by comparing the input and output tuple values to the statement parameters and result values in the execution log and inductively constructing a generalized program.

Language of Logs and Programs

The WbE universe assumes a database D and a fixed language U consisting of a set of parameterized statements types. One embodiment of the present invention includes nine statement types, although the present invention may also be implemented with more, fewer, or different statement types. In one example, the nine statement types are bind, update, query, find-one-result, read-result, commit, rollback, setAutoCommit and endlog.

The statement bind (x,y) attempts to unify x and y, where x and y are variables or constants. The result of bind is success and the associated unified variables, if any, or failure.

The statement update (p,v,u) carries out a parameterized update to a database table, such as SQL INSERT or DELETE statements. The parameters to an update are the column names p and values v to be assigned to the SQL update expression u. This allows parameterization of update values and WHERE clause values. The result of update is either success and D is modified or failure (for example, due to an exception or integrity constraint violation) and D is unchanged. (Note that transaction processing semantics are permitted, so success or failure can be determined on a temporary copy of the database.)

The statement query (p, v, q) performs an SQL SELECT statement and is parameterized in the same manner as update, allowing additional parameterization of ORDER BY clauses. A successful execution of the query results in success and result set of the answer to the query. An error during query processing (e.g., a type error on the argument) results infailure.

The statement read-result records the results of a query execution. A query and its result are paired via a unique identifier.

The statement find-one-result (p,r) takes as input a result set r returned from a query call and a query template p, then attempts to find a single row in that result set, using the query template as a template for binding to column values. The result matching parameters are tuples consisting of a table column name, a data type string, and a variable or a value which will be passed to bind. If all three parts of each tuple in the query template are matched successfully by only one row in the result set, find-one-result returns the matched row successfully. Otherwise, find-one-result fails.

The statements commit, rollback and setAutoCommit represent the execution of the corresponding SQL statements.

The endlog statement is added to the log when the user selects “Stop Recording.”

Programs and Scripts

Log

Execution logs follow a similar format to final WbE programs, with a few additions. Each update and query statement in an execution log contains a unique id. Execution logs also have a new result statement, which contains a query id and a list of tuples describing the column name, data type, and value for a result row, as it was read by the form system. Only column values which were actually read from the row by the form system appear in a result statement.

A log L is a sequence of instances of U. All statements in a log are grounded, that is, the statements do not contain variables. Logs do not contain bind or find-one-result statements.

Correctness

WbE is given an input I, consisting of a set of tuples. Each tuple represents an action to be performed on D. WbE is also given a set of examples E. Each example is the triple (i, l, o) such that i∈I, I∈L and o is an output tuple. A program P is correct, where P⊂U, if P executed on every i⊂I does not generate an exception or a failure. This definition of correctness does not cover any semantic notion of correctness. A user can easily create a rule that, say, replaces last names by office numbers. Thus, preview mode is essential for the user to have confidence in the workflow generated by WbE.

Method

This section describes the implementation of one embodiment of the present invention. To connect the invention to an application/database, an engineering procedure is performed on the application, described in the next section. The monitor module, learning module and execution module are then described.

Engineering Procedure

Data Domains

We have extended the JDBC API within the driver with data domains to guide the induction algorithm described below. These domains are specified by the user or developer using altered getX( ) and setX( ) calls of PreparedStatement and ResultSet objects. For each call to getString( ), setInt( ), etc., the user or developer specifies an extra string, indicating the domain to which this value belongs. For example, to fetch a string phone number, the String pn=rs.getString (pnatt, “phone number”); method is called, where pnatt is the schema attribute name and phone number is the label of the domain. Using data domains, WbE can easily differentiate between values expected to be used as, for example, office numbers, rather than employee ID numbers or telephone extensions.

Using Transactions

In working with early embodiments of WbE, it was found that the ability to preview effects of the tool's use was important to user acceptance, since the consequences of script execution can be large. In order to support WbE's preview ability, applications must explicitly wrap statements that will alter the underlying database (such as INSERT, UPDATE, DELETE) with transaction calls via the JDBC driver. For example, such updates should be preceded by a call to setAutoCommit(false) and followed by calls to commit( ) and setAutoCommit(true). The driver logs these transaction management calls so that the execution module may later use them to roll back updates when a user wishes to preview the effects before committing to a set of changes. Explicit BEGIN, COMMIT, ROLLBACK requests made via SQL statements are not supported by this version of WbE.

Result Batching

To preserve logical grouping of results read from ResultSet objects into rows, the logging driver does not actually log the data read from a particular row until a call is made to next( ) or close( ). This limitation should encourage developers to group reads from Result Set object into batches, followed closely by calls to next( ) or close( ) before values from those objects are used in further SQL statements.

Limiting Application Logic

WbE has access to application/database 26 behavior through two mechanisms: the JDBC driver and through explicit application calls that WbE can make. Thus, any logic that occurs on the application/database 26 side of the driver (through stored procedures or other mechanisms) is handled automatically. Any application logic not visible through the application/database 26 interaction which affects query or update parameters (such as math or string operations) will render WbE unable to learn scripts involving these steps without additional information from the application or the user. This restriction may seem severe, but since many modern applications use the Model-View-Controller paradigm, there is already explicit application layer access to the model, reducing the work required.

Monitor Module

When the user 20 initiates recording of a demonstration, the Monitor Module 28 begins recording a new log. As the user 20 demonstrates the task, traffic between the form system 24 and its support application/database 26 are monitored and logged. The Monitor Module 28 currently logs: queries executed by PreparedStatement objects (these appear as query( ) actions in the log), updates executed by PreparedStatement objects (these appear as update( ) actions in the log), values and column names read by ResultSet objects, including the domains of the values (these appear as read-result( ) actions in the capture), and in addition to those mentioned above, calls to setAutoCommit( ), commit( ) and rollback( ) (these appear essentially unchanged in the log and give WbE the ability to preview database 26 updates safely).

Queries and ResultSet reads are tagged with unique IDs in order to link them together for execution. The need for this will become clear during the induction step (the Section herein below entitled “Learning Module”).

For this example, the monitor module recorded the log shown in FIG. 14. This log shows the form system searching a database table employees for a record whose lastname column matches the search string provided by the user. Next, a result is read containing the matching lastname, as well as the associated firstname and eid, the record key for the employee table. This information is used by the form system to display the results of the search (FIG. 7). When the user clicks on the search result, the form system generates a new query to get the information about the selected employee. This query, and the returned values read from the result are indicated in the log. Finally, the user makes the change to the employee record and the form system performs an update, which is the last event in the log before the user closes it. The system is now ready to generate a script from this captured data and the input provided by the user.

Learning Module

The task for this component of the system 10 is to generate a script based on the input example and task capture that can then be applied to any similar task. The module 30 begins script creation by reading the example (the first row) from the input file. This example is an input array, i, and it will be used to replace the specific values used in the capture log with variables that can be bound to new values. The workflow output values provided by the user are also put into an array, o. Finally, the log is read. as an array, S, with each query, update, or result read making up an element in the array.

To create a general script from the specific example, the WbE system 10 uses an inductive algorithm, make_script, that generalizes the specific information in the example to a set of variable relationships. Rule induction is a process that takes as input the following information: the inputs, i, and outputs, o, provided by the user, and the recorded log, S. It produces: sets of variables, î and ô, which will be bound to new inputs during execution, a generalized script, Ŝ, and a set of result templates, Q, describing how each query's results should be handled. We refer to each element of S as S₁, S₂, etc, and a similar notation for elements of the other arrays and lists.

make_script(i,o,S)→(î,ô,Ŝ,Q) (1)

Induction begins by creating the î and ô arrays. These arrays are of the same length as their counterparts, i and o, with each member being a unique new variable. Additionally, two temporary lists, r and \hat{r}, are created for storing all tuples read from ResultSet objects. Once the replacement variables and local variable lists have been created, for each action Sᵢ in the capture log, create a script action, Ŝᵢ, as illustrated below in Table 1:

TABLE 1

If the action is any of setAutoCommit ( ) , commit, or rollback, copy the action
verbatim into Ŝᵢ.
If the action is a query ( ) or an update ( ) , copy the action, its ID, and its
non-parameterized contents over to Ŝᵢ. Then, iterate over each var (domain, value)
tuple and

| | |
|---|---|
| 1. | Attempt to replace value by finding a match in i or o. If a match is found, use |
| | the corresponding variable from î or ô to replace value in Ŝᵢ. |
| 2. | If no match was found, repeat the search using all local values stored so far in r. |
| | Matching for these values is more restricted, since domain must match the |
| | data domain of the result, as well as the value itself. Should a match be found, |
| | value will be replaced in Ŝᵢ with the appropriate variable from \hat{r}. |
| | Additionally, the matching result in r will be flagged as having been |
| | referenced. |
| 3. | Finally, if there is still no match, then value is copied into Ŝᵢ verbatim. |

If the action is a read-result ( ) , create new lists to add to the result tuples, rⱼ
and \hat{r}ⱼ, then iterate over each value(column, domain, value) tuple and

| | |
|---|---|
| 1. | Attempt to replace value by finding a match in i or o. If a match is found, then |
| | value is replaced in \hat{r}ⱼ by the corresponding value from î or ô. If the match |
| | was from o, then the result will be flagged as having been referenced. |
| 2. | If no match was found, then value is considered to be new information. It is |
| | given a new variable in \hat{r}ⱼ. |
| 3. | Finally, add rⱼ and \hat{r}ⱼ to their respective lists. |

If the action is an end_log, finalize the script and create the result templates, Q, for
handling query results.

Result templates are created by iterating through every unique query ID in the log file and finding all read-result( ) actions in r with the same ID that were referenced by some query( ), update( ), or that matched any values in o. Due to limitations in the present induction algorithm, if more than one such result is found, script creation fails and the user is offered the chance to attempt to create a script using the next example in the input file, which may be a better example. If only one result is referenced, the corresponding template from \hat{r} is placed in Q as the template for evaluating its parent query. If no results are referenced, a blank template is added to Q and the query is effectively ignored. Because the read-result( ) used to create the template has been matched against the input and output tuples provided by the user, some relationships may be established which effectively cause the resulting program to expect a result set value to match the one passed in by the user for all future steps. This works in addition to matches on values query( ) and update( ) to create extra constraints for row matching during execution. These additional constraints imply that, for this example, the first name in a result row must match the one in the input tuple, though the user never specifies this explicitly. Further examples which violate these extra constraints will cause the script to fail. This has the implication that extra information in the input file may be used to create constraints that insure a correct workflow.

This naive induction algorithm is sufficient for dealing with small logs, such as those generated from simple database management forms using search-based navigation. More complex systems, such as those which present elements to the user in a dropdown list, produce many more query results in the execution log. This result ‘noise’ greatly slows down the search process of finding variable replacement matches in result sets, as each new value must be compared against all previous results until a match is found or no results are left. With this in mind, a second indexed induction algorithm was implemented so as to store read-result tuples in a hash table, indexed by the string value they produced from the database. These two methods are compared in the Section hereinbelow entitled “Evaluation Framework” and in sections following the “Evaluation Framework” Section.

FIG. 15 shows the results from applying this induction procedure to part of the log. At this point, the execution module is ready to execute the script over the rest of the data in the input file to generate a preview of the script's effects.

Execution Module

Rule execution begins by combining the generalized script Ŝ with new input values i. Each variable in î is bound to it's new value from i, propagating this new value throughout the script. The Execution Module then proceeds to iterate through Ŝ, executing each action as illustrated below in Table 2:

TABLE 2
update ( ) actions are executed by creating and executing an SQL string. The string
is created by iterating over each element in the update ( ) tuple, combining the raw
strings in single quotes with the quoted values from each var (domain, value) tuple.
The resulting string is executed against the database. If the update should fail for any
reason, the input tuple is marked as having failed at this step and execution halts for
the failing example.
query ( ) actions are executed much like update ( ) actions. A string is built from
the strings and var ( ) values in the query ( ) tuple, and the resulting string is
executed against the database. A failure of the query also results in aborting execution
for the failing example, and the input tuple is marked with the step at which it failed.
query actions also implicitly call find-one-result using the result template
for this query, which is stored in Q.
find-one-result ( ) is called implicitly after a query and uses a passed-in
result set and a result template to match against rows in the result set. This template
consists of a list of tuples describing a column name to read from the result set, a data
domain to restrict wild matches, and a constant or a variable to bind against the
result set data. For a given value (column, domain, value) tuple in the result
template, the value of the column named column is read from the result set, and a
bind is attempted against the value in the result template. If bind fails for any of
the tuples in a template, the row is considered a non-match. If only one row is found
which matches the template, the call to find-one-result is successful. If no
rows match, or more than one matches the template, the input tuple is marked as
having failed at this step, and execution halts for the failing example.
commit, rollback, and setAutoCommit ( ) are executed immediately. If one
of these actions fail for any reason, the input tuple is marked as having failed at this
step and execution halts for the failing example.

Execution Results

When no more actions are left in a script, the present example is marked as a success. As each tuple from the input file is executed, information about its success or failure, and any output values that have been bound are collected for display to the user. Examples that fail at the same step are grouped together, and their outputs discarded as unreliable. Examples that succeed are grouped together, and their outputs stored together in an outputs table.

### Rule Failure Example

Not all tuples in the example input file executed successfully. For example, the tuple (‘Bradbury’, ‘Mitchell’, ‘7158’),as well as the othertwentytwo failures, failed at the initial step of the script. The initial step was the query step which performs a search for an employee based on last name. None of the 23 failure cases returned a successful match in their result sets. While in this example all the tuples failed in the same way, many failure modes are possible: misspelled names, last name collision with different first names, etc. Failed examples are grouped by the step in the script at which they failed, and are passed along to the WbE UI when the user chooses to make a new script for handling them.

Preview Implementation

Rule execution takes place in two modes: preview and commit. In preview mode, execution proceeds normally for all actions except the commit action. When commit is encountered in preview mode, a rollback is executed in its place. As a side effect, this effectively causes each execution of the script to occur ‘in a vacuum’ with respect to the others, such that later examples cannot count on the outcome of prior execution. Commit mode is identical to preview mode, except that it honors the commit actions, allowing changes to be committed to the database.

Backward Chaining

Both the naïve algorithm and the indexed algorithm process the log from the start to the end. In another embodiment of the invention, a backwards induction algorithm was implemented. In this implementation, the output and update operations of log are identified by scanning from the end of the log backwards to the beginning. For each output and update, the set of required parameters are identified. For each parameter, the algorithm works backwards through the log, identifying the sequence of queries and input items that generated each parameter. The idea behind backward chaining is to improve performance of a program by removing statements which (1) can never be reached due to control statements (2) avoiding calculations or data manipulations which are never used, (3) allowing WbE to ignore coincidental matches in data that do not affect future processing.

The backward chaining algorithm works as follows:

1. Iterate over the script in order to create:

1 (a) A quick-access hash (hashed by each tuple value) of all result( ) tuples in the script, each tagged with a line number indicating when it appeared in the log.

1 (b) An “unresolved” stack of tuples whose values have not been considered. Each update( ) should be pushed onto this stack, tagged with its line number, indicating when it appeared in the log. User-specified “output” tuples are pushed onto the stack before iteration.

1 (c) A quick-access hash (hashed by query id) of all query( ) tuples, tagged with a line number indicating when it appeared in the log.

2. Pop elements off of the resolve “stack”, attempting to find the result source in the log (if any) of the given value.

2 (a) If the element is an output element, check all results in the results hash matching that value.

2 (a)(i) If no match is found, assume the value is a constant and move on.

2 (b) If the element is a query( ) or update( ) value, attempt first to resolve it against the input values.

2 (b)(i) If a match is found in the input values, link the two values with a variable and move on.

2 (b)(ii) Otherwise, treat it like an output element and search the result hash as described above.

2 (c) When all elements from a given query( ) or update( ) are resolved into variables (or left as constants if they could not be resolved), it should be added to the “top” of the script.

Evaluation Framework

In order to understand the potential impact of WbE, we conducted experiments to measure WbE's performance in various learning conditions, in an execution condition, and in comparison with performing an experimental task “by hand”, using a web-based forms system. A “deployment evaluation” was also performed, to explore the impact of attempting to use WbE on existing systems.

Algorithm Evaluation

As mentioned earlier, the initial induction algorithm used by the present invention performed poorly as the number of query results increased. To evaluate this, and to compare the iterative induction method with the hash-based induction method, we compared the script-learning times for both algorithms in various learning situations. Each algorithm was to learn a simple script for looking up a person's information amongst the results of a query listing all people in the database, using their first and last name as identifiers, then to collect various pieces of information about the person, before updating the person's phone number in the database. The algorithms performed this task in five conditions with increasing amounts of ‘result noise’. The five experimental conditions contained 0, 25, 50, 100, and 200 non-target results which must be considered by each algorithm. In addition to varying the number of ‘extra’ results that must be handled, each algorithm was run in a ‘best case’ and ‘worst case’ condition, where the target result was either the last result seen (best case), or the first result seen (worst case).

In addition to understanding learning performance time, we wanted to evaluate the overhead of executing these WbE scripts within an interpretive environment, versus a hand-constructed program for performing the same task. Using the same ‘look up, gather information, update’ task described above, a WbE script was constructed and run with varying amounts of ‘result noise’. Additionally, a Java program was hand-crafted to mimic the behavior of the WbE script, and measured in the same conditions. The results of these comparisons can be found hereinbelow in the Section entitled “Results”.

User Experience Evaluation

To understand the potential impact of WbE for users, we conducted a pilot study on 8 human participants. The experiment was a between-subject design, conducted by presenting each participant with the same task of 16 updates to the database, in one of two conditions: either using a form interface to update the database directly, or using the forms augmented by WbE. The main task consists of performing two types of updates to the database, all in the same format. Nine of the 16 updates consist of looking up a person in the database and updating their information according to the values of a spreadsheet. The people listed in the other 7 updates did not yet exist in the database, requiring the user to add them, using the forms. Each condition included a training example to teach users how to perform updates and additions using the forms, in the forms-only case, and to perform the task using WbE and WbE's exception handling feature in the WbE case.

Participant performance was measured on completion time and errors. We chose these metrics to evaluate WbE because, from the user's point of view, script induction and execution are effectively instantaneous. The primary bottleneck to the system is the use of the tool and the class of scripts that can be generated by the induction procedure.

Deployment Evaluation

WbE was deployed on a web-based database forms system as a means to connect two application/databases. The first application was a scheduling optimizer, which dealt with constraint-based planning of events. The second application was a database-backed website which used a set of web-based forms to maintain the database. The problem that WbE solved was that of connecting these two applications/databases. When the optimizer made changes to the schedule, the changes could be output in a format readable by WbE, giving details about the name, location, date, start time, and duration for each event. The form system for maintaining the schedule website was altered such that it would produce logs for WbE. Once these two pieces were in place, WbE could be used to create a workflow program that would take a schedule. delta file from the optimizer as input, and would update the website's database to reflect the changes that had been made. This deployment resulted in some interesting discoveries and solutions about the effective workings of WbE. These are discussed in detail in the Section entitled “Results”.

Results

Algorithm Evaluation Results

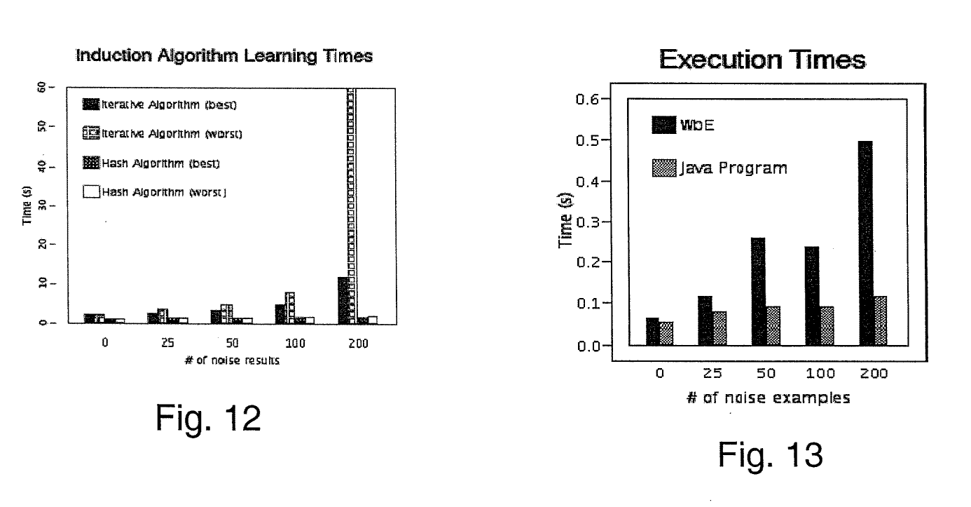

Results of the learning algorithm evaluation can be seen in FIG. 12. The graph shows that the iteration-based induction algorithm can take exponential time in the number of results that it must consider. This is especially evident in the worst case. Additionally, the hash-based algorithm takes slightly more time as the number of results that it must store increases, but this doesn't seem to present a scaling issue.

Results of the execution algorithm evaluation can be seen in FIG. 13. This graph shows that the scripting environment overhead adds significant time to each example as the number of ‘noise results’ increases. Future work will decrease this overhead by improving the handling of noise results.

User Evaluation Results

Results of the user evaluation revealed an average time of 3.19 minutes to complete the task with WbE, and an average time of 7.5 minutes to complete the task in the ‘by hand’ condition. A two-tailed, unequal means, t-tailed test comparing the completion times of the participants indicates that the mean time to complete the tasks is very significantly different in the two tasks (p value 0.01), and show that WbE provides a significant speed increase over performing the task by hand. There were no errors made by participants in either condition, so no comparison can be made between the systems with respect to errors.

The times recorded in the user evaluation show that WbE provided a 235 increase over performing 16 updates by hand. From this result, it can be seen that WbE provides a speed increase over the manual condition after only 8 updates.

### Automated Workflow Embodiment

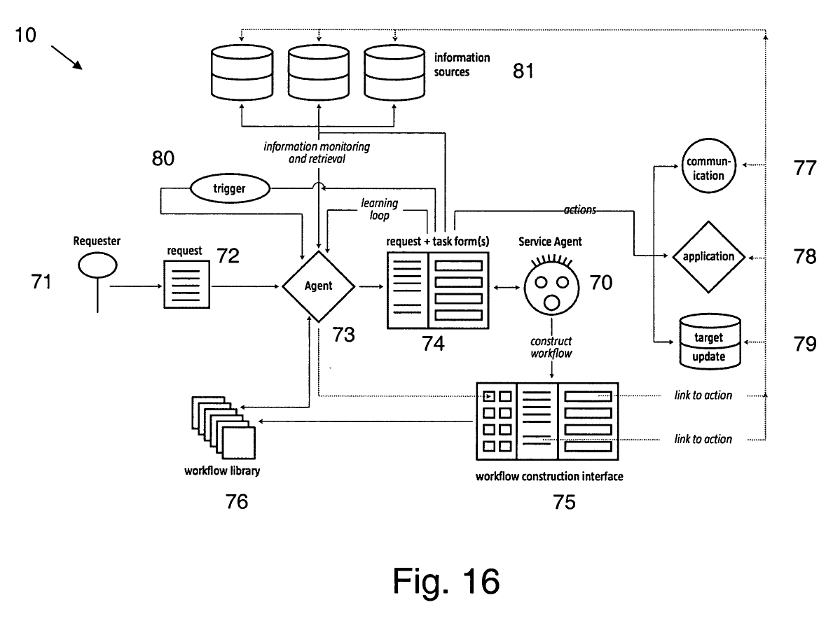

FIG. 16 illustrates another embodiment of a WbE system 10 according to the present invention. An automatic workflow scenario will now be described in specific examples including multiple different users. In this scenario, a user named “Steve” is an associate dean at a small college. One of his duties is to help enforce internet policies for the school. Steve operates in the role of a service agent 70.

The scenario begins when a member of the IT department, operating in the role of requester 71, at the college sends Steve 70 a request 72 in the form of an email, informing him that a set of students have exceeded the Internet bandwidth limit set by the school.

The system 10, acting as an agent 73, reads this incoming email and finds a corresponding workflow in the workflow library 76 that tells it what to do. The agent 73 gathers additional information on the students from various information sources 81, including student school databases. These information sources 81 return year (class), major, list of any previous disciplinary actions, photos, and schedule of classes of students.

The agent 73 then modifies the incoming email request 72 by adding the supplemental background information on the students and additional tasks forms 74. The agent 73 also creates a new outgoing email communication 77 from Steve 70 to each student asking to schedule an appointment. The message offers a variety of possible time based on Steve's 70 calendar (acquired through the application interface 78) and the student's class schedule. Finally, the agent 73 sets a timer for three “school” days. The timer is recorded as a target update 79. The agent 73 then sends the new email message into Steve's 70 mailbox

Steve 70 sees the new email from the IT department and opens the request and task forms 74.

Steve 70 looks over the additional data and sees that a student is an IS major, which means the student should probably understand the schools internet policy. This fact reduces the likelihood that Steve 70 will be lenient.

Steve 70 clicks on a link in the email that opens the agent 73 to compose an email to a student. He looks over the proposed meeting times and removes a few because he thinks he might be busy at those times. He 70 sees that a timer has been set for three school days and clicks the send button to send the email to a student. Thereafter, Steve 70 returns to his other work.

Three school days go by and no response from Tim arrives. The agent 73 responds to the timer alarm trigger 80 by fetching the original IT department e-mail, the outgoing message to a student, and by fetching the student's photo and class schedule (again through a workflow rule in the workflow library 76 trained for this situation through the workflow construction interface 75). This information is displayed to Steve 70.

Steve 70 looks at the class schedule and the photo of the student and decides to be more proactive and meet the student as he leaves his chemistry lecture.

### Workflow Construction Embodiment

The present invention will now be described in terms of a workflow construction scenario. In this scenario, a user named “Sally” is a graduate student coordinator at a small college. She has the role of service agent 70. One of her duties is to pull together summaries of the incoming graduate student applications and send them to the various faculty members on the admissions committee.

Sally 70 attends the kickoff meeting of the graduate student admissions committee. At the meeting, one of the committee members says it would be great is if applications could be prioritized so that reviewers read applications of students who had letters written by people the reviewer knows.

When Sally 70 gets back to her office, she decides to construct a workflow to help her meet this request. She 70 launches the workflow construction interface 75 and makes a new workflow to address the two requests.

Sally 70 first chooses to address the issue of letter writers the reviewers might know. She has no way of knowing whom the members might know, but she has some ideas about how to approximate this information. She knows that the members will know their collaborators for research publications. She also suspects that members will more likely know letter writers that are from institutions where the member received their degree or where they previously worked.

Sally 70 constructs a workflow that first extracts the name and organization of each letter writer in the application by showing the system where this information is located in an information source 81. She then provides the workflow construction interface 75 with a list of the committee members and instructs it 75 to check if any of the letter writers match as co-authors on the committee members' webpages 81. If there is a match, she instructs the interface 75 to add the members name, the letter writers' name, the symbol “co” on the coversheet of the application, via a target update 79. She 70 adds this workflow to the workflow library 76.

Next Sally 70 demonstrates to the interface 75 how to get the previous affiliations of the various committee members from an information source 81. She observes as the system 10 does this, correcting it when it makes an error and improving its learning. When it's complete she save this workflow in the workflow library 76 with the name “find faculty affiliation”.

Next Sally 70 creates a third workflow This workflow searches for a match between the member's affiliation and the letter writer's organization. This search is a workflow that composes the two previous workflows. When there is a match, she instructs the interface 75 to add the member's name, the letter writer's name, the letters “aff”, and the actual affiliation to the coversheet of the application.

Sally 70 can easily use this information from the coversheets to quickly assign different applications to different members for the first round of reviews. Finally, Sally 70 shares this workflow with other workers providing the same service agent 70 role.

Multi-System Workflow

The present invention will now be described in terms of multi-system workflow. This use of the present invention is important because organizations often work together to accomplish a task. However, workflow between organizations is often poorly organized due to the problem of data integration of multiple sources and targets of information. Workflow By Example lowers the cost of data integration.

Consider the transaction of buying house. This transaction involves eight roles of individuals and institutions. (Each role corresponds to an individual or a team of individuals.). The roles are: (1) the seller of the house, (2) the real estate system 10 that represents the seller, (3) the buyer of the house, (4) the real estate system 10s that represent the buyer of the house, (5) the bank of the seller that owns the house, (6) the bank of the buyer that finances the purchase of the house, (7) the insurance company of the buyer of the house, and (8) the title company that process the title check of the house. In this embodiment, there is more than one user 20.

Each one of these roles involves a different company or individual and a different IT system (the IT system ranges from simple spreadsheets to complex IT workflows). The present invention allows each individual or company to implement a piece of the global “sell and buy a house transaction”. These pieces together constitute a global workflow system. This implementation is accomplished by giving WbE example complex transactions that combine incoming messages, the local IT system, and outgoing messages. (Note that currently these transactions are done repeatedly by hand.)

For example, the seller of a house sends a message to a real-estate system 10 indicating that they wish to sell a house. Upon receiving the message, the real-estate seller system 10 starts several transactions. The first transaction involves data entry into a database (or update of an existing record) about the location of the house and a variety of details. An appointment is also set up between the seller and the real-estate system 10 to review the house and determine any work that needs to be done. Also, an open house is scheduled, etc. Eventually bids are made on the house again via electronic communications between the seller real-estate system 10 and potential buyer real-estate system 10s (not shown). Finally a buyer is chosen. The various contractual agreements, the set-up of the title search, etc. are all issued via WbE rules of the seller real-estate system 10 as messages to other organizations. These messages are received by the WbE instances of these other organizations and again local databases are updated to record the new work requests

Aggregation of Data Streams in Syndication Scenario

Consider data streams generated by a collection of sources (for example, news stories from Associated Press or other organization, a stream of updates and discussions in netnews, blogs, or RSS/ATOM fields from an organization, financial reports to EDGAR, updates to a website, updates to a wiki site, electronic votes from a voting system, contest scores in sports, weather reports, the stream of information about friends, or associates such as location or other information, credit reports, reports of transactions about a person or organization or by a person or organization, data generated by game playing, etc.). Each one of these streams can be processed by WbE to perform inserts, modifications, and updates to an existing database. These updates can store the contents of the streams, perform additional extraction on the stream, reference resolution of the entity instances on the streams, perform look-ups of additional correlative information from additional sources, etc. to construct a database of related documents and facts. WbE can also be used to then distribute the resulting transformed information to other sources, thus serving as a processing warehouse for content syndication, either for an individual or organization. The warehouse itself can be used for information retrieval, information routing, information integration, query answering, information intent, information filtering, interaction with intelligent mixed-initiative dialog systems, etc.

Note that at any stage in this use case or any other use case in this document, WbE may deal with text (formatted in a variety of ways), multiple languages, audio, video, presentations, diagrams, illustrations, spreadsheets or any other electronic encoding of information.

Constraint Checking Between Data Sources

WbE can also be taught to verify constraints. Consider the example where a person has organized a meeting and booked a time and location for the meeting. The meeting requires a vendor to deliver something to the meeting (food, projector, flowers, etc.). In this example, there is an equality constraint that exists between the vendor order and the meeting. If the meeting time or meeting location changes then the constraint is violated. If the vendor cannot complete the order at the specified time and location for whatever reason, then the constraint is violated. We check these two constraints with WbE in three steps.

The user presents a vendor order as a data item to WbE. The user then demonstrates the recording of the vendor order in a meeting database.

The user then demonstrates to WbE how to check, upon arrival of a vendor order confirmation, that the time and location of the order match the meeting. If the meeting and the order match. This demonstration records the success or failure of the check in the database.

Symmetrically, the user demonstrates to WbE how to check updates to the meeting database for the corresponding changes in the database. Upon update to the meeting database, WbE invokes the rule to check. If the rule invokes an exception, the constraint has been violated, and the user is notified.

Note that the scenario requires a business key for the meeting that is shared between the vendor database and the meeting database. This business key does not have to be exact, just an approximate set of attributes that identifiers the appropriate meeting with high probability.

In addition, WbE handles multiple vendor orders for a meeting and multiple meetings for a vendor order.

Extract-Transform-Load From a Source Data Source to a Target Data Source

WbE can also be used between two data sources. The user issues a query to the source data source to generate the set of items. The user then interacts with the system 10 to process the data item into the correct form in the target data source. A variation of this embodiment of the invention includes a plethora of source data sources and a plethora of target data sources.

Conclusion

The present invention has been described in terms of a WbE embodiment, a system that allows users to define workflows by example. We describe the system architecture, algorithms, and user interaction.

The WbE system allows the automation of tasks that can be accomplished with interaction with forms. These tasks include repetitive sequences of updating, querying; adding, and deleting information from a database or application. The system facilitates these tasks over a set of input data, even if the input varies with respect to the types of actions that must be performed to complete the task over the input set. Altogether, WbE gives users the ability to automate certain kinds of data integration or workflow tasks in an ad-hoc manner.

An evaluation of the WbE embodiment shows that this embodiment reduces the time required to perform simple tasks compared to manually completing the task. If the task contains more than eight tasks to be performed, WbE is more time efficient than manual updates. A user study indicates that the mean completion times in the WbE case and the manual case are significantly different (p<0.01). In addition, evaluation of the learning algorithm and the execution algorithm indicate that the algorithms scale well as the input examples increase in length.

Although the present invention has generally been described in terms of a WbE system, and in terms of specific embodiments and implementations, the present invention is applicable to other methods, apparatuses, systems, and technologies. Those and other variations and modifications of the present invention are possible and contemplated, and it is intended that the foregoing specification and the following claims cover such modifications and variations.

1. Computer-readable memory including computer readable instructions which, when executed by a processor, cause the processor to perform steps comprising:
identifying a set of data, wherein the data includes a plurality of items;
prompting a user to process at least one item of the data in a predetermined manner, wherein the user interacts with a predetermined form system to process the data;
monitoring input of the user, wherein the input of the user causes at least one item of the data to be processed in the predetermined manner;
producing computer-generated, computer-readable instructions in response to monitoring the input of the user, wherein the computer-generated, computer-readable instructions cause the processor to process data in the predetermined manner;
executing the computer-generated, computer-readable instructions, wherein the computer-generated, computer-readable instructions operate on at least one item of the data.

2. The computer-readable memory of claim 1, wherein prompting the user to process at least one item of the data in a predetermined manner includes:
executing the predetermined form system;
presenting the user with the predetermined form via the predetermined form system;
prompting the user to process at least one item of the data via the predetermined form system;

3. The computer-readable memory of claim 1, wherein prompting the user to process at least one item includes:
generating an interface for receiving input from the user; and
executing the predetermined form system.

4. The computer-readable memory of claim 1, wherein the predetermined form system includes a computer user interface including at least one item selected from a group comprising: a text box, a pull down, a radio button, a check box, a single selection list, a multi-selection list, a table, and a spreadsheet.

5. The computer-readable memory of claim 1, wherein monitoring input from the user includes monitoring data flow between an form system running on the processor and an application/database.

6. The computer-readable memory of claim 1, further comprising after executing the computer-generated, computer-readable instructions:
displaying results of the execution of the computer-generated, computer-readable instructions on the at least one item of the structured data;
prompting the user to identify whether the results of the execution of the computer-generated, computer-readable instructions are correct.

7. The computer-readable memory of claim 1, wherein the memory includes data indicative of processing at least one item of the data in a predetermined manner, and further comprising after executing the computer-readable instructions:
creating data indicative of results of executing the computer-generated, computer-readable instructions operating on at least one item of the data, wherein the data indicative of results of executing the computer-generated, computer-readable instructions operating on at least one item of the data is different from the data indicative of processing at least one item of the data in a predetermined manner.

8. The computer-readable memory of claim 7, further comprising after creating data indicative of results of executing the computer-generated, computer-readable instructions operating on at least one item of the data:
prompting the user to identify whether the results of execution the computer-generated, computer-readable instructions are correct;
determining that the results of execution the computer-generated, computer-readable instructions are correct; and
changing the data indicative of processing at least one item of the data in a predetermined manner to include data indicative of the results of executing the computer-generated, computer-readable instructions operating on at least one item of the data.

9. The computer-readable memory of claim 6, further comprising after prompting the user to identify whether the results of the execution of the computer-generated, computer-readable instructions are correct:
determining that the results of the execution of the computer-generated, computer-readable instructions are not correct;
prompting the user to process the at least one item that was not processed correctly by the computer-generated, computer-readable instructions;
monitoring input from the user when the input from the user causes the at least one item that was not processed correctly to be processed in the predetermined manner;
modifying the computer-generated, computer-readable instructions in response to monitoring input from the user, wherein modified computer-generated, computer-readable instructions cause the processor to process data in the predetermined manner;
executing the computer-generated, computer-readable instructions, wherein the computer-generated, computer-readable instructions operate on at least one item of the structured data.

10. The computer-readable memory of claim 1, further comprising:
receiving input from the user indicative of an additional constraint for processing the structured data;
modifying the computer-generated, computer-readable instructions in response to monitoring input from the user, wherein modified computer-generated, computer-readable instructions cause the processor to process data in the predetermined manner and with the additional constraint.

11. The computer readable memory of claim 10, wherein modifying the computer-generated, computer-readable instructions includes generating additional computer-generated, computer-readable instructions in response to monitoring input from the user.

12. The computer-readable memory of claim 1, further comprising:
receiving input from the user indicative of an additional process to be performed on the data;
monitoring input from the user indicative of the additional process to be performed on the data;
modifying the computer-generated, computer-readable instructions in response to monitoring input from the user, wherein modified computer-generated, computer-readable instructions cause the processor to perform the additional process on the data.

13. The computer-readable memory of claim 1, further comprising:
sharing computer-generated, computer-readable instructions between users through a cooperative interface.

14. The computer-readable memory of claim 1, further comprising: identifying at least two sets of data, wherein each data set includes a plurality of items.

15. The computer-readable memory of claim 1, wherein producing computer-generated, computer-readable instructions includes producing computer-generated, computer-readable instructions to identify data that contains errors.

16. The computer-readable memory of claim 1, wherein producing computer-generated, computer-readable instructions includes producing computer-generated, computer-readable instructions to identify references to related data.

17. The computer-readable memory of claim 1, further comprising: at least two users collaboratively processing at least one item of data in a predetermined manner.

18. A system comprising:
a processor;
an input device connected to the processor;
an output device connected to the processor; and
memory including computer readable instructions which, when executed by the processor, cause the processor to perform steps comprising:
identifying a set of data, wherein the data includes a plurality of items;
prompting a user to process at least one item of the data in a predetermined manner, wherein the user interacts with a predetermined form system to process the data;
monitoring input from the input device, wherein the input causes at least one item of the data to be processed in the predetermined manner;
producing computer-generated, computer-readable instructions in response to monitoring the input, wherein the computer-generated, computer-readable instructions cause the processor to process data in the predetermined manner;
executing the computer-generated, computer-readable instructions, wherein the computer-generated, computer-readable instructions operate on at least one item of the data.

19. A method to automate a procedural task, comprising:
identifying a set of data, wherein the data includes a plurality of items;
prompting a user to process at least one item of the data in a predetermined manner, wherein the user interacts with a predetermined form system to process the data;
monitoring input of the user, wherein the input of the user causes at least one item of the data to be processed in the predetermined manner;
producing computer-generated, computer-readable instructions in response to monitoring the input of the user, wherein the computer-generated, computer-readable instructions cause a processor to process data in the predetermined manner;
executing the computer-generated, computer-readable instructions, wherein the computer-generated, computer-readable instructions operate on at least one item of the data.
